(19) United States
(12) Patent Application Publication
(10) Pub. No.: US 2021/0340384 A1
(43) Pub. Date: Nov. 4, 2021

(54) INTUMESCENT POLYACRYLIC ACID COMPOSITIONS

(71) Applicants: CASE WESTERN RESERVE UNIVERSITY, Cleveland, OH (US); SWIMC LLC, Cleveland, OH (US)

(72) Inventors: Erik Price, Cleveland, OH (US); Carol Fleetwood, Lancashire (GB); Sharon Hilton, Lancashire (GB); Gary Wnek, Cleveland, OH (US)

(21) Appl. No.: 17/284,632

(22) PCT Filed: Oct. 14, 2019
(86) PCT No.: PCT/US2019/056082

§ 371 Date: Apr. 12, 2021

Related U.S. Application Data
(60) Provisional application No. 62/744,669, filed on Oct. 12, 2018.

(51) Int. Cl. C09D 5/18; C09D 7/65; C09D 7/61; C09D 163/00

(52) U.S. Cl. CPC C09D 5/185; C09D 163/00; C09D 7/61; C09D 7/65

(57) ABSTRACT

An intumescent composition based upon modifications to poly acrylic acid (PAA), including certain additives, is contemplated. Such compositions may be incorporated in epoxy and other resin-based coatings. The PAA may be modified through the use of one or more mineralizing additives to promote char formation.

### CROSS REFERENCE TO RELATED APPLICATIONS

This application claims priority to United States Provisional Patent Application serial no. 62/744,669, filed on Oct. 12, 2018. This application is incorporated by reference herein.

### TECHNICAL FIELD

The present invention relates generally to intumescent compositions and, more specifically, to intumescent coatings incorporating modified or unmodified polyacrylic acid compositions. The polyacrylic acid may be modified by compounds such as mineral acids, metal hydrates, inorganic silicates and/or phosphates, and/or organic species such as weak organic acids and/or polyvinyl alcohols.

### BACKGROUND

Polyacrylic acid (PAA) is a synthetic high-molecular weight, polycarboxylic acid (—CH₂CH(COOH)—)ₙ polymer formed by the polymerization of acrylic acid. PAA is used in many applications such as ion exchange resins, adhesives, and detergents. It is also used in areas such as, in thickening, dispersing, suspending, and emulsifying agents in the pharmaceutical, cosmetic, and paints industries.

In the last fifty years, fire-retardant materials have become increasingly important, particularly with respect to the manufacture of consumer goods, construction materials, and other commonly used and/or mass-produced articles. Insofar as many fire-retardant materials incorporate specialized chemical compounds, it is often useful to coat the fire-retardant(s) onto a substrate rather constructing the article entirely from the fire-retardant material itself.

Fire-retardants applied to a substrate function in any combination of ways to protect the substrate. Some materials will endothermically degrade upon exposure to fires or high temperature, thereby removing heat energy from the substrate. Additionally or alternatively, fire-retardants can produce a char which acts as a thermal barrier to reduce the rate of heat transfer to the substrate. As a final mechanism, some fire retardant materials release compounds upon exposure to heat so as to dilute the combustible reactants (e.g., inert or non-combustible gases) or mop up the free radicals produced from the burning material and slow the fire growth.

Intumescent coatings are a form of passive fire protection, usually applied as a thin film, that swell many times their original thickness forming an insulation char. This acts as a barrier between the fire and substrate (such as structural steel). Intumescent coatings are often categorized according to the type of fire they are designed to provide protection against, for example, cellulosic fueled or hydrocarbon fueled fires.

Intumescent coatings are particularly utilized for application on structural steel (e.g., beams, columns, plates, etc.) and other metal structural components to prevent collapse and/or structural compromise. They also have application on bulk-heads, deck-heads, and firewalls of structures as a further protection for occupants during a fire event.

Conventional intumescent coatings are composed of a polymeric binder, a source of acid, a charring agent, and a blowing agent.

When intumescent coatings are exposed to fire or excessive heat, the source of acid decomposes to provide an acid. The charring or char-forming agent (carbon source) reacts with the acid to form a carbonaceous char, simultaneously the blowing agent degrades to produce a non-flammable gas (e.g. ammonia). The gas evolved serves to create an expanded carbonaceous char/foam. This thick, porous, highly-insulating, nonflammable, solid foam protects the substrate it covers from incident heat.

Cellulosic fueled fires are typical of modern day commercial and infrastructure projects in the Built Environment, usually for architectural applications internally and externally exposed structural steelwork. The cellulosic standard fire test curve (British Standard BS 476-20 Cellulosic) reaches 500° C. within about 3 minutes and rises to in excess of 1000° C. (i.e., 1832° F.) over 90 minutes.

Hydrocarbon fueled fires are typical of oil and gas installations. The hydrocarbon standard fire test curve (BS 476-20 Hydrocarbon) reaches 500° C. within 1 minute and rises to in excess of 1000° C. (i.e., 1832° F.) in about 8 minutes.

Hydrocarbon fueled jet fires are highly erosive, extremely turbulent fires (ISO 22899-1), and have an immediate heat rise to 1100° C. Fires of this nature experience heat fluxes in the order of 250Kw/m².

Intumescent coatings need to produce a tough, hard, strong, and compact char foam which is robust enough to resist the extreme erosive forces of the hydrocarbon-fueled jet fires, and maintain adhesion to the substrate (structural steel in this case). Boric acid is often used in intumescent coatings for hydrocarbon-fueled jet fires as it assists in producing a strong boron oxide ceramic type char with good adhesion.

When used, boric acid has four main functions in an intumescent coating:
(1) Endothermic Cooling—Boric acid dehydrates at 100° C. to form metaboric acid. This cooling effect helps against the intense heat of the fire. The most critical aspect of bulkhead testing is to ensure the protected steel does not exceed ˜160° C. for 1 hour (140° C. above ambient start temperature), to ensure human survival inside the steel structure and/or to prevent combustible materials that may be present on the non-fire side from igniting, as is required for IMO A754(18)E approval. In turn, this provides very early cooling in a fire due to its endothermic release of water at ˜100° C.
(2) Acid Functionality—As the heat increases, metaboric acid continuously reacts with the resin binder (typically epoxy/polyamide) to produce a carbon char. This acid catalysed degradation of the epoxy resin on heating produces a char residue.
(3) Boric acid works synergistically with other intumescent active ingredients, thereby lowering the degradation temperature. This also produces positive effects on the melt viscosity. At temperatures above 250° C. more dehydration occurs forming boron oxide, a hard mineral glass.
(4) Vitrification—Boron oxide crystals begin to break down at 300° C. These crystals melt and continue to react with other key components such as ammonium polyphosphate, forming an extremely hard, ceramic char composed of borophosphates. A series of suboxides are also produced with partial melting until full fusion is reached at 700° C. For example, boron trioxide—a glassy solid—may be produced so as to act as a fire barrier.

Boric acid is currently classified by the European Chemicals Agency (ECHA) as a Category 2 Reprotoxin. It is also on the ECHA SVHC (Substance of Very High Concern list) and is likely to move onto the ECHA authorization list. This would mean a ban on its use unless authorization is sought and approved. Boric acid is a component of epoxy intumescent coatings allowing the products to achieve effective jet fire resistance and bulkhead fire protection on steel.

When boric acid is removed, intumescent coatings typically rely on boron additives, metal oxides, expanded graphite, reinforcing agents such as carbon fibers, and/or or other char strengthening compounds to establish the necessary strong char structure to resist a jet fire. These materials can restrict char expansion, compromising the thermal protection while potentially possessing their own environmental and/or health concerns. The endothermic cooling effects of boric Acid (particularly required for steel bulkhead and deck head protection) are also often lost. Carbon fibers can also be difficult to incorporate into the paint during the manufacturing process leading to a highly viscous product.

At present, Jotachar JF750 from Jotun (Sandefjord, Norway) is one type of commercially available epoxy intumescent coating. Chartek 7 by Akzo Nobel (Amsterdam, the Netherlands) and Firetex M90/02 by Sherwin Williams (Cleveland, Ohio, USA) are other examples of epoxy intumescent coatings. Additional intumescent and/or fire-retardant products may be sold under these or other tradenames by each of these respective entities or other entities.

United States Patent Publication 2016/0145466 discloses intumescent coatings that are suitable for protecting substrates against hydrocarbon fires, such as jet fires. The compositions include thermosetting polymer(s), curing agent(s), phosphoric and/or sulphonic acid, metal or metalloid ions, and an amine functional blowing agent. As such, the intumescent coating can be used without a supporting mesh.

United States Patent Publication 2016/0152841 contemplates similar types of intumescent coatings. Here, boric acid may be used in addition to the phosphoric/sulphonic acid(s), and melamine and isocyanurate are also included. Metal or metalloid ions are not required.

United States Patent Publication 2016/0145446 describes a further iteration in comparison to the above referenced documents. In this instance, the intumescent comprises thermosetting polymer(s), curing agent(s), phosphoric and/or sulphonic acid, metal or metalloid ions, and urea-, dicynamide-, and/or melamine-based blowing agent(s).

United States Patent Publication 2016/0160059 provides an intumescent coating based upon an organic polymer, a spumific, and an additive providing a combination of two different sources of metal/metalloid ions. Hydroxy-functional polysiloxanes are claimed in this particular use, and specific types of metal atoms are recited.

In still a further example, United States Patent Publication 2015/0159368 describes a liquid intumescent coating with at least one ethylenically unsaturated monomeric polymer resin. The resin is cured by free radical polymerization adhesively bound onto a reinforcement structure, such as inorganic fabric.

Finally, academic publications by Edward Weil, with the Polytechnic Institute of New York University and the team of Caroline Gerard, Gaelle Fontaine, and Serge Bourbigot have described various fire-protective materials that may or may not be intumescent in nature. In this same manner, Jimenez, Duquesene, and Bourbigot describe the mechanism of action for boric acid and coated ammonium polyphosphate as flame retardants.

### DESCRIPTION OF THE DRAWINGS

Operation of the invention may be better understood by reference to the detailed description taken in connection with the following illustrations. These appended drawings form part of this specification, and any information on/in the drawings is both literally encompassed (i.e., the actual stated values) and relatively encompassed (e.g., ratios for respective dimensions of parts). In the same manner, the relative positioning and relationship of the components as shown in these drawings, as well as their function, shape, dimensions, and appearance, may all further inform certain aspects of the invention as if fully rewritten herein. Unless otherwise stated, all dimensions in the drawings are with reference to inches, and any printed information on/in the drawings form part of this written disclosure.

In the drawings and attachments, all of which are incorporated as part of this disclosure:

FIG. 1 illustrates the known reaction mechanisms for poly acrylic acid (PAA) with respect to (A) dehydration, (B) decarboxylation, and (C) chain scission.

FIG. 2A is a thermal gravimetric analysis (TGA) in air of a PAA showing weight change with temperature including endothermic reaction after 190° C. Final residual solids at 600° C. were less than 1% (low ash value) TGA graphs shows, weight percentage (wt. %) drop with temperature and the derivative weight change (%/° C.).

FIG. 2B is a thermal gravimetric analysis in air of an exemplary PAA compound fully neutralized (with 0.5M NaOH) showing weight change with temperature that demonstrates that the final residual solids at 600° C. had increased to >50% (increased low ash value).

FIG. 2C is a thermal gravimetric analysis in air showing weight change with temperature of Trisodium Citrate Dihydrate with sodium metasilicate and PAA-Na (fully neutralized with 0.5M NaOH) 25:25:50 weight ratios, respectively. The final residual solids at 600° C. were ˜65%.

FIG. 3A is a photograph of PAA mixed with inorganic compounds and citric acid within an intumescent paint after a propane torch test. This formed a foam char.

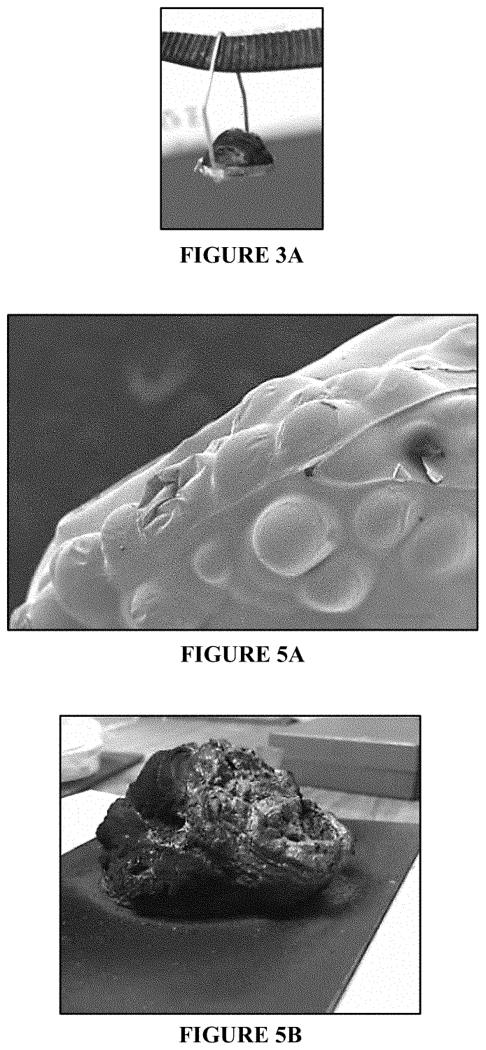

FIG. 5a is photograph of PAA gel heated to 300° C.

FIG. 5b is a photograph of PAA expanded with epoxy/amine.

FIG. 6 is a photograph PAA with ZnCl₂ before and after heating to at 600° C.

FIG. 7 is a comparative set of TGA graphs of Linear PAA (left) and NaOH treated Linear PAA (PAA-Na) (right).

FIG. 8A is a TGA graph of PAA; FIG. 8B is a TGA graph of PAA-COOH/Na⁺; FIG. 8C is a TGA graph of PAA-fully Na⁺; and FIG. 8D is a TGA graph of PAA-Ca²⁺.

FIG. 9 is a series of TGA graphs of PAA crosslinked or linear with sodium metasilicate or citric acid, as indicated in the legends beneath each graph.

FIG. 10 show a series of photographs, corresponding to the materials disclosed in FIG. 9 (including the legends indicated beneath each picture), of burn tests.

FIG. 11A is a TGA graph of TCD; FIG. 11B is a TGA graph of TCD:SM (50:50); and FIG. 11C is a TGA graph of TCD:SM:PAA-Na (25:25:50).

FIGS. 12A is a TGA graph of CA; FIG. 12B is a TGA graph of CA: SM (50:50); and FIG. 12C is a TGA graph of CA: SM: PAA-Na (25:25:50).

FIGS. 13A through 13C are TGA graphs of additional embodiments, as indicated in the legend of each drawing.

FIG. 14 shows results of microscale combustion calorimetry on various salt forms of PAA.

FIG. 15 is a photograph of char after Meker fire test (as contemplated by Table 3) based on modified PAA with inorganic compound and weak acid.

FIG. 16 are before (left) and after (right) photographs of the propane torch test on the exemplary PAA coating.

FIG. 17 is a photograph of Meker test performed on the exemplary PAA coating.

FIG. 18 describes the conditions and shows photographs of the cone heater results for an example boric acid-free experimental formulation containing PAA.

FIG. 19 is a graph comparing results of cone calorimetry on boric acid and PAA containing coatings.

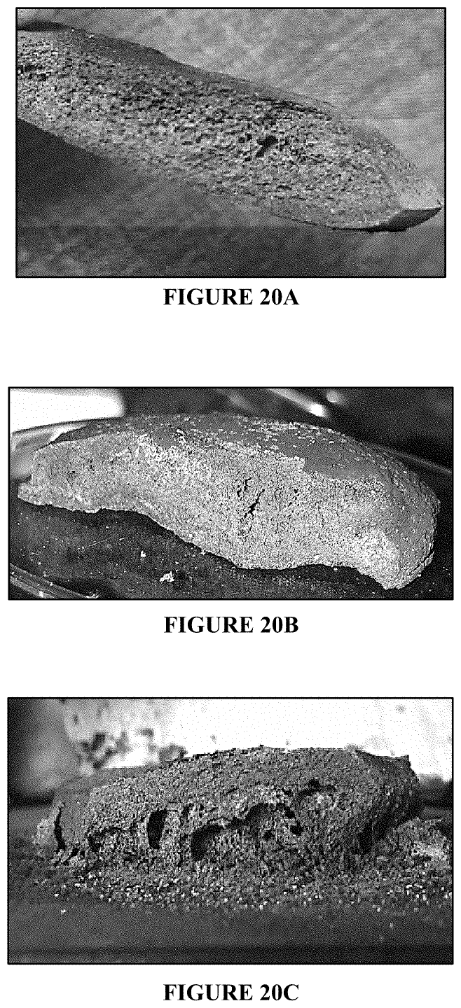

FIGS. 20A through 20F show the char structure produced by Meker testing on formulations 1, 2, 3, 4 and 5 from Table 4, while FIG. 20F shows the same in a commercially available boric acid containing formulation.

FIG. 21 is a time v. temperature curve to quantify the performance of certain intumescent coatings against intumescent paints containing PAA.

### DETAILED DESCRIPTION

Specific reference is made to the appended claims, drawings, and description, all of which disclose elements of the invention. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Table 1 indicates salient acronyms used throughout this disclosure.

TABLE 1
Acronyms used in this disclosure.

| Compound | Abbreviation |
|---|---|
| Poly(acrylic acid) (untreated) | PAA |
| Poly(acrylic acid) (NAOH treated) | PAA—Na |
| Sodium metasilicate | SM |
| Trisodium citrate dihydate | TCD |
| Citric acid | CA |
| Poly vinyl Alcohol | PVOH |

As a preliminary matter, all of the aforementioned patent publications are incorporated by reference as if fully rewritten herein. In particular, these disclosures provide further information on the state of the art and the types of resins, curing agents, binders, and blowing agents that may find utility in combination with the inventive aspects described and/or claimed below.

Poly(acrylic acid) (PAA) is a weak polyacid (pKa ˜4.5) commonly used in consumer products. PAA has an inherently low heat release capacity (HRC) and total heat release (THR) relative to other polymeric materials.

PAA comes in powder form, is easy to incorporate, and can produce a lower viscosity product compared to products with carbon fibres. In turn, this make PAA-based products easier to apply due to the omission of carbon fibres, as well as imparting superior aesthetic appearance.

The inventors discovered that compounds based on poly(acrylic acid) (PAA) modified with certain PAA-modifying compounds demonstrates intumescent behavior that may be suitable for hydrocarbon-fueled fire. These PAA modifiers may contain and introduce into the PAA multivalent ions such as (but not limited to) Ca²⁺ or Na⁺. Additionally, these PAA modifiers may be selected from weak organic acids, minieralizing additives, polyvinyl alcohol, polyvinyl acetate, and/or inorganic components such as silicates, chlorides, carbonates and hydrates.

Such modified PAA used as a part of the intumescent package (i.e., in greater than 5 wt. % of the entire formulation) tends to control char expansion without the need for fibres or boron additives. The char formed can be modified by adding different levels/types of PAA mixed with inorganic compounds and or weak acids or PVOH to give structural similarities to intumescent paints with boric acid. Modified PAA with and without inorganic compounds has been found to release water at temperatures >120° C. providing an endothermic response.

Therefore, this modified PAA can potentially provide the four main functions required in an intumescent coating: 1) very early cooling in a fire due to its endothermic release of water at 120° C., 2) acid catalyzed degradation of the epoxy resin on heating, (3) synergistic reactions with other intumescent active ingredients, and 4) production of a hard strong foamed char which could perform as a fire barrier.

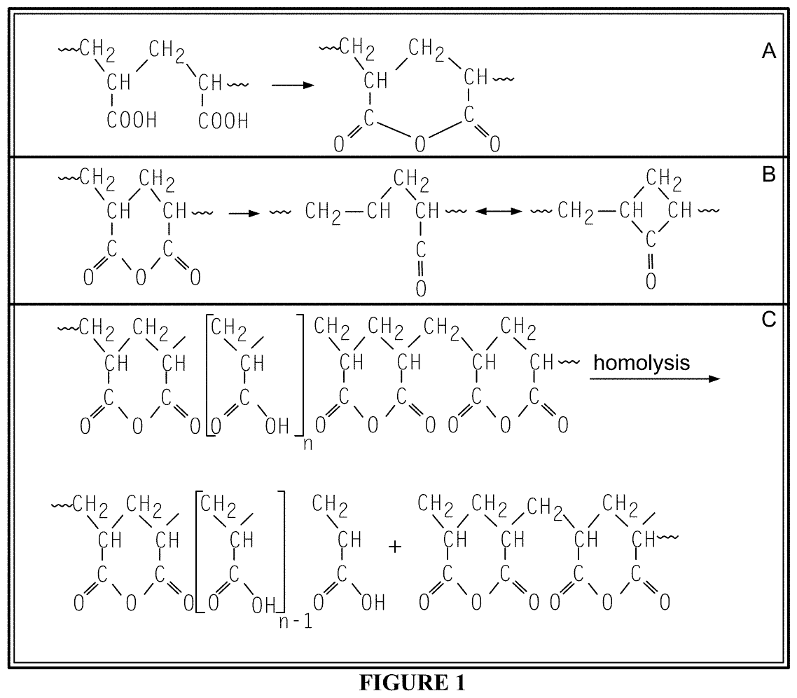

With reference to the drawings, these reactions are illustrated. In FIG. 1, the dehydration step (a) begins above 140° C. to create a temporary, carboxylated ring structure within the PAA chain, with the water formed supporting an endothermic response. In particular, water and carbon dioxide produced can cool a flame and dilute volatile fuel and oxygen necessary for combustion. Next, as seen in step (b), decarboxylation occurs within the main chain, which then undergoes chain scission as shown in step (c). The remnants of this chain provide a backbone for charring, while volatiles released during these reactions may serve as a blowing agent into the carbon matrix.

Table 2 shows the known and previously reported literature values for the degradation of PAA, demonstrating endothermic reactions.

TABLE 2
Temperatures for the degradation of PAA
Summary of thermal analysis for PAAc in air

| | TGA and DTG | | | | |
|---|---|---|---|---|---|
| | Onset | DTG peak | Mass loss | DTA peaks | DSC heat |
| Stage | (° C.) | (° C.) | (%) | (° C.) | (J/g) |
| 1 | 70 | 100 | 1.7 | — | — |
| 2 | 132 | 302 | 27.6 | 235, endo | 393 |
| 3 | 325 | 420 | 38.4 | exo | — |
| 4 | 448 | 519 | 31.1 | 507, exo | — |
| Total | | | 98.8 | | |

With reference to the discussion above, the inventors sought materials that met at least one of the following criteria: endothermic release of water above 100° C. (more preferably between 120° C. and 160° C.), an ability to catalyze char formation prior to reaching vitrification temperatures, and an ability to vitrify char.

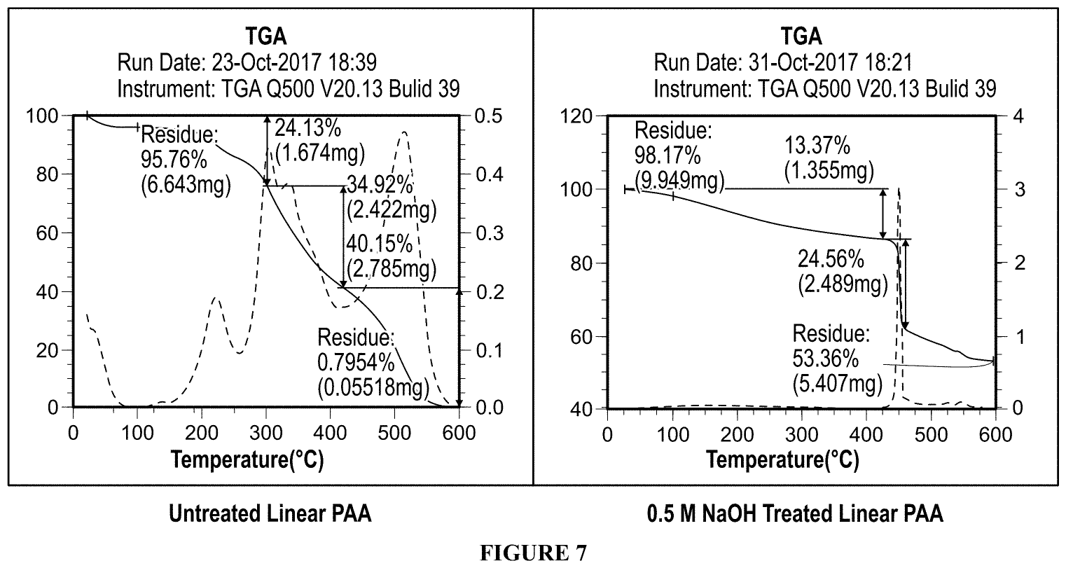

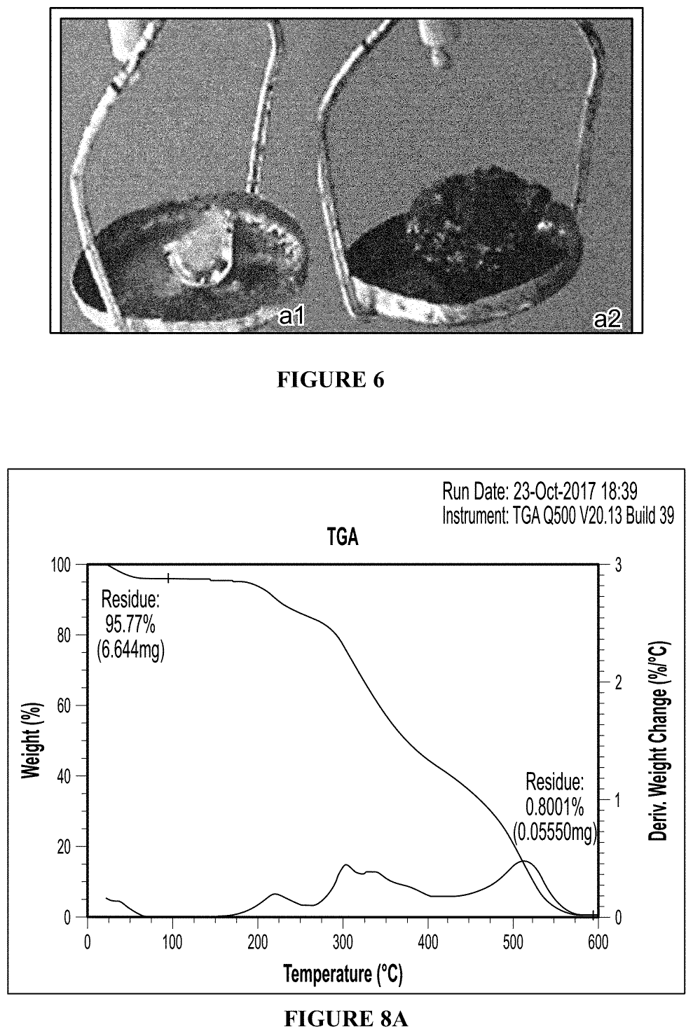

Three main processes accompany the decomposition of PAA: 1) Dehydration (endothermically releasing carbon dioxide and water which can cool a flame), 2) decarboxylation and 3) back bone reactions with some char formation. In other words, PAA may function in ways similar to boric acid. PAA also has an inherently low heat release capacity (HRC) and total heat release (THR) relative to other polymeric materials. In addition, the structure of PAA is a polymeric backbone with carboxylic acid groups. This carbon backbone should lend itself to charring. The release of volatiles will then likely blow this carbon matrix foam (FIG. 5A—photograph of PAA gel heated to 300° C. and FIG. 5b—photograph of PAA expanded within an epoxy/amine system).

The acid groups may also provide acid catalyzed dehydration of the epoxy/Amine (or Polymer) Therefore, the inventors identified PAA and modified PAA as potentially promising intumescent additives.

PAA is a relatively low-cost material used in many applications including super-absorbents (as alkali metal salt forms), ocular drug delivery systems, emulsion thickeners, emulsion polymers, and pigment dispersing agents, with the emulsion and pigment dispersing functions adopted within various chemical coating applications. However, PAA has received very limited attention in its own right as an additive to impart fire resistance to epoxy resins and other polymer systems, which necessarily requires certain modifications and other unique considerations (e.g., total mass provided to the formulation, molecular weight of the PAA, etc.) simply not encompassed by the aforementioned prior uses.

While the inventors are aware of instances where PAA has been used in layer-by-layer deposition techniques for fire-retardant materials, PAA in these applications merely entraps clay platelets (and/or other similar substances) between the layers. As such, this approach requires multiple coating applications. Also, the resulting layer-by-layer films are much thinner (usually on a nanometer scale, as compared to the 10+micrometer coatings contemplated herein), and the PAA is not serving as an intumescent agent.

Another previous example of PAA appearing in intumescent compositions can be found in U.S. Pat. No. 6,207,085. Here, expandable graphite is used in combination with a fire retardant based upon alkyl diamine phosphate. Here, a resinous emulsion with a Tg below −40° C. is formed and preferably includes an inorganic filler, such as clay. The resin itself may include polyvinyl acetate, polyacrylic acid silicone, or styrene-butadiene latex, although the resin does not contribute to the intumescent aspects of the composition (which come from the expanded graphite and alkyl diamine phosphate). In U.S. Pat. No. 5,968,669 and International Patent Publication WO 2011/60832, PAA (in the form of polyacrylic latex and PAA alkyl or aryl esters, respectively speaking) are provided in resins, in combination with expanded graphite and various other intumescent packages. Finally, in International Patent Publication WO 2001/005886, an intumescent composition relies on a char former, a polymeric binder, a crack control agent, and an optional surfactant that may include PAA as a dispersant and is, therefore, provided in comparatively small amounts (<3.0 wt. %) in water-based coating systems.

In order to understand why expanded graphite repeatedly appears in many of these prior uses, it was understood that PAA has a low char yield (low ash values). Thus, PAA's failure to form a thermally protective char barrier may be why, prior to this discovery, PAA was not considered for use as an intumescent agent.

The inventors discovered modified PAA's ability to coordinate with a number of ions was found to dramatically change its residual char yield. A number of inorganic compounds and/or metals associated with or incorporated as hydrates, hydroxides, silicates, phosphates and the like can be incorporated with PAA (and/or in the coating formulation itself) to enhance char formation, as will the additional and use of weak organic acids (i.e., those having pKa values between 1.0 and 6.7 and pH ranging from 1.0 to 6.5) . In addition, it was discovered that polyvinyl alcohol and/or polyvinyl acetate can also enhance the char formation. In this manner, by providing any of these modified forms of PAA and its derivatives, it becomes possible to rely upon PAA as a char forming agent, as well as to deliver the other functionalities previously associated with boron-based additives.

A number of investigations into PAA and its derivatives were conducted, as described in more detail below. In particular, the PAA may be neutralized, partially neutralized, or un-neutralized, as well as cross-linked, partially cross-linked, or non-cross-linked.

Additionally or alternatively, the inventors incorporated inorganic compounds into or in combination with PAA in various coatings. These inorganic compounds may include (but not limited to) metals (example Al, B, Zr, Cu, Zn, Na, K, Mg, Ca, Sr, Si, Ti,) associated with or incorporated as hydrates, hydroxides (e.g. NaoH or CaoH), oxides, bicarbonates, silicates, carbonates, sulfates, nitrates, phosphates, chlorides and the like, and complexes thereof.

Metal carbonates, metal bicarbonates, metal hydrates, metal phosphates, metal chlorides, metal sulfates, metal silicates, metal nitrates, and metal borates are compounds in which metal atoms are bonded to hydrates, hydroxides, oxides, bicarbonates, silicates, carbonates, sulfates, nitrates, phosphates and chlorides, respectively. In these compounds, the metal ions are bonded to the above-listed functional ions in proportion to balance the charges on the metal ion. They may contain one or more different types of metal ions. These compounds are known to the person skilled in the art. For example, a source of metal hydrate is trisodium citrate dihydrate, and a source of metal silicate is sodium metasilicate.

A source of metal/metalloid atoms may also be a complex comprising metal ions bonded with more than one of the following counter ions: hydrate, hydroxide, carbonate, silicate, bicarbonate, chloride, phosphate, sulfate, nitrate, and borate ions. Preferred sources of metals ions, for use in the present invention include for example sodium metasilicate and trisodium citrate dihydrate.

Hydrates can be for example mono, di, tri, tetra, penta, hexa, hepta, octa, nono and deca functional.

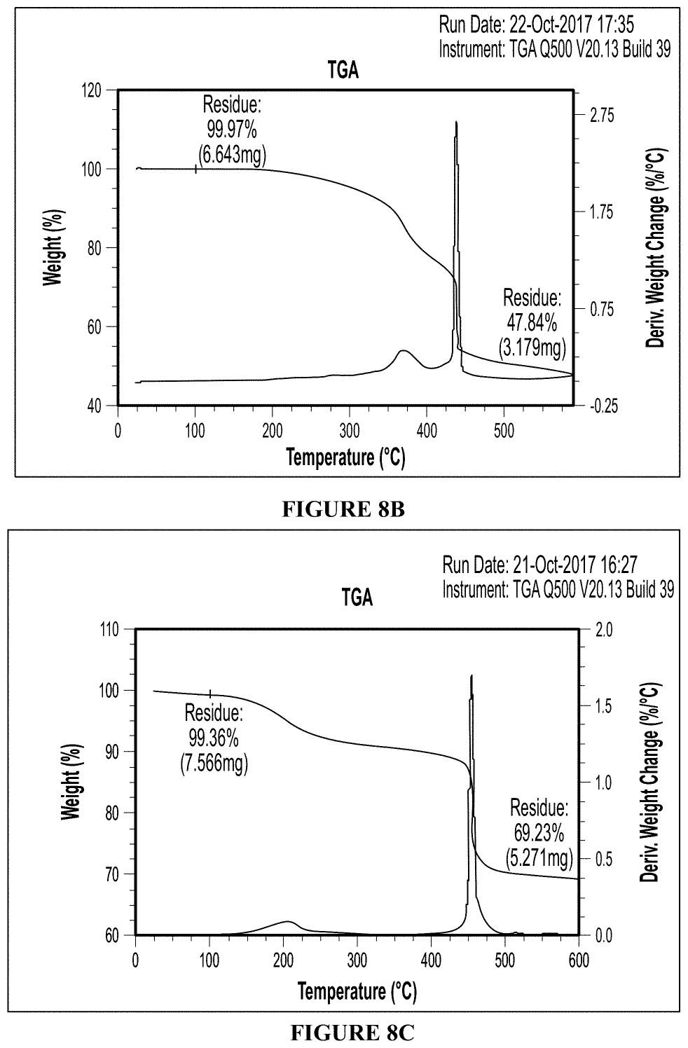

In order to increase the intumescent structural rigidity and add other synergistic effects to PAA, the inventors mixed PAA with inorganic compounds to neutralize it with various ions. FIG. 6 shows the char formation of a zinc-neutralized PAA on heating.

In addition, incorporating a weak acid such as citric, tartaric acid, ascorbic acid, lactic acid, formic acid, acetic acid, oxalic acid, uric acid, malic acid, itaconic acid and the like showed improved intumescent properties.

Resin-based (with curing agents, where appropriate) coatings are of particular interest, the materials and approach described herein could be incorporated into any number of other resins and coating systems, including epoxies, amines, amides, acrylics, vinyl esters silicones, polyurethanes, polysiloxanes, polyurea, ketones, unsaturated polyesters, acrylates vinyl acetates, methacrylates and derivatives thereof and the like. The resins could be thermoplastic or thermoset.

The organic thermosetting polymer maybe one or a mixture of more than one different organic thermosetting polymers including hybrids. The organic thermosetting polymer may comprise but is not limited to one or more of the following functional groups: epoxy, amine, urethane, isocyanate, ester, vinyl, vinyl ester, amide, mercaptan, carboxylic acid, acryloyl, methacryloyl, anhydride, hydroxyl, and alkoxy groups.

The thermosetting polymer may also be an ethylenically unsaturated acrylate peroxide or UV cured resin such as methyl methacrylate.

The thermoplastic polymer may be based on monomers such as vinyl acetate, vinyl toluene, styrene and other vinyl and acrylic moieties.

All coatings contemplated herein normally exceed 5 micrometers in thickness. When applied to a substrate, the dry film thickness of the layer of intumescent coating is typically between 1 mm (millimeters) and 40 mm. The dry film thickness may be measured using an Elcometer Dry Film Thickness Gauge.

To be clear, depending upon the application, values outside of these minimum and maximum ranges may be possible, and the stated values herein are merely exemplary of preferred and/or likely ranges. Any and every combination of the individually stated minimum and maximum limit are encompassed

The inventive compositions herein are well suited for coating on steel substrates, and particularly structural steel beams and columns and other load-bearing or non-load-bearing components. To the extent the intumescent agent is incorporated with epoxy or other thermosetting or thermoplastic resins and curing agents, the inventive formulations can serve as a direct replacement for previously known, structural coatings.

As a further note, past examples incorporating meth(acrylic) acid and/or poly(acrylamide) should not be confused with the poly(acrylic) acid and derivatives, as contemplated in this disclosure. While these other materials may have utility in flame retardant coatings, they may have different (and less favorable) heat release capacities, meaning that when they are burned, they release different amounts of heat in comparison to the inventive PAA compounds.

It was contemplated that modified PAA (as contemplated herein) could, among other things, serve as a cooling and/or blowing agent and produce a hard strong foamed char which could perform as a fire barrier, particularly for high temperature, hydrocarbon-type fires.

In this regard, PAA eliminates the need for introducing or relying upon matrix materials such as carbon fibres In fact, owing to its powder form, PAA (in most of its various forms) lends itself to lower viscosity formulations that are easier to apply and/or impart a superior aesthetic appearance.

Without wishing to be bound by any specific theory or mode of operation, the inventors realized that modified PAA would serve as an excellent intumescent owing to its three-stage degradation. In the first step, occurring at greater than 140° C. in most forms tested (and approximately 170° C. in some of the examples below), two carboxylic acid groups come together to form an anhydride ring, releasing water (cooling agent) in the process. Subsequently, the second mode of degradation begins at 200° C. and corresponds to decarboxylation via anhydride ring cleavage, resulting in the release of CO₂ (blowing agent). Finally, at higher temperatures, polymer main chain scission occurs, fracturing polymer chains along the backbone. It should be noted that the only difference between linear PAA and its lightly-crosslinked counterpart is ease of handling the solid form, with crosslinked samples being more cooperative. With respect to thermal stability, lightly-crosslinked and linear sodium treated PAA samples have negligible difference.

Inventors discovered treating any form of PAA with either Ca(OH)₂ or NaOH increased and improved the intumescent properties with respect to char development performance.

For the avoidance of doubt, the features provided in the above description can be combined in any order. The appended figures and specific examples described herein are intended to illustrate the invention but are not to be construed as limiting in any manner the scope thereof.

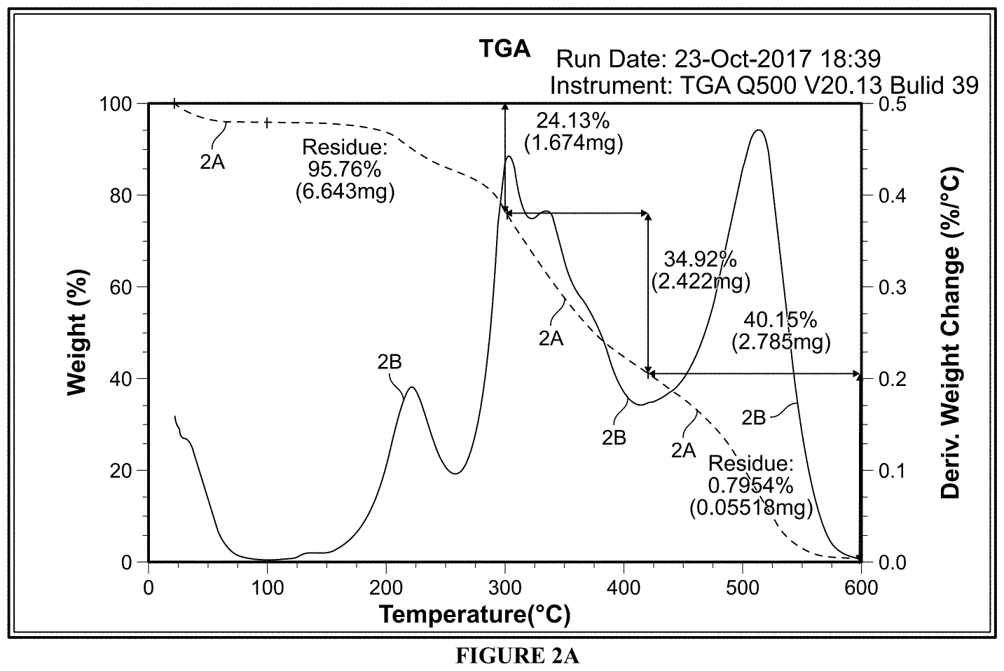

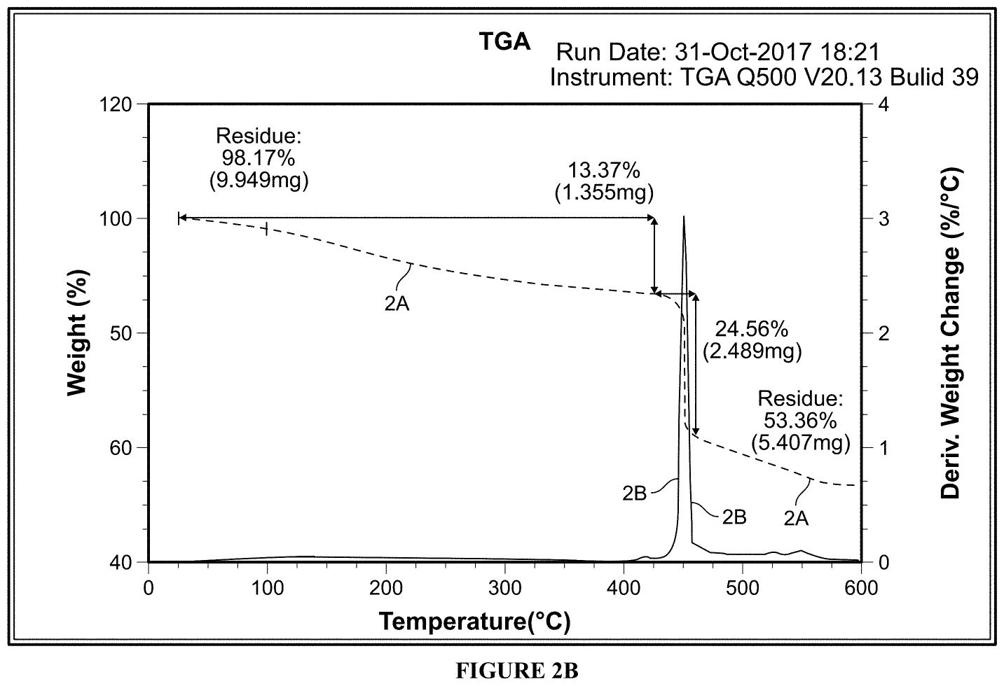

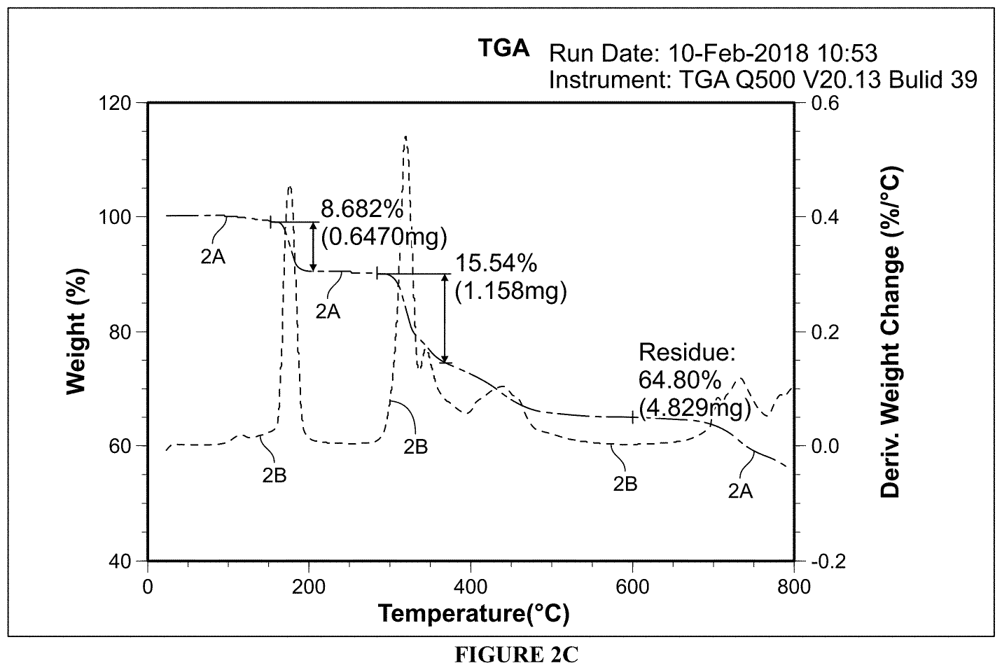

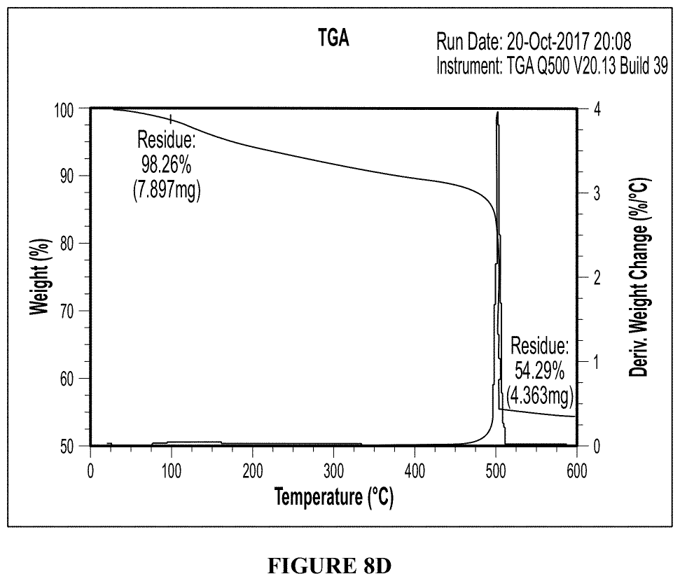

For example, as described above, FIGS. 2A through 2C show other TGA graphs. More significantly, FIG. 7 demonstrates that treating linear PAA with NaOH (metal hydroxide) increased the residual solids on PAA.

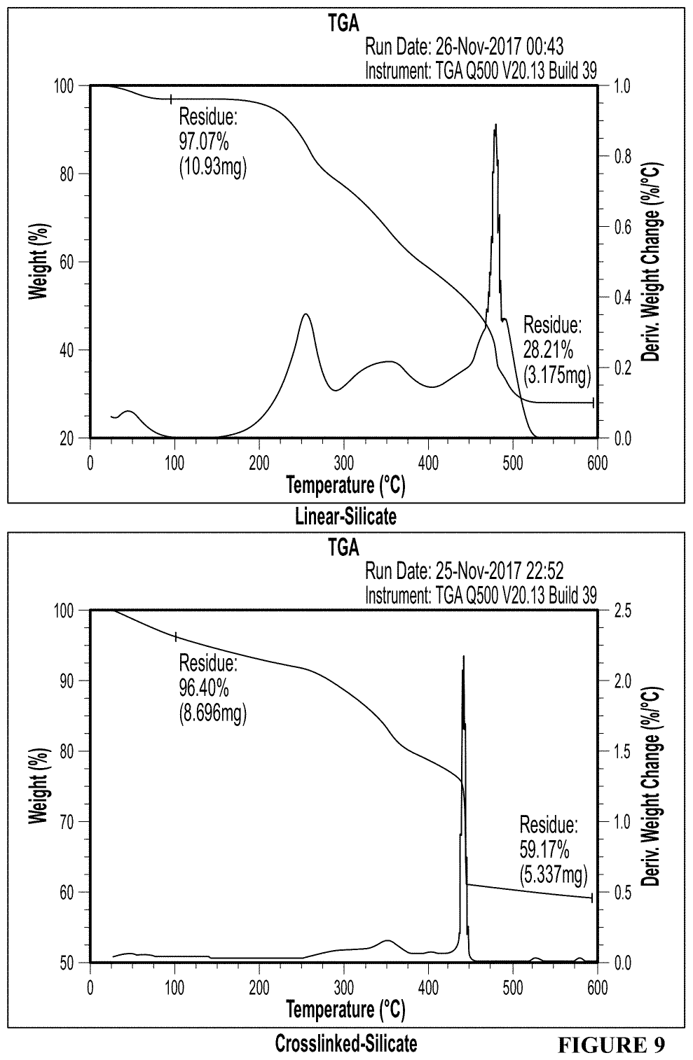

Upon performing degradation analysis (e.g., FIGS. 8A to 8D), interesting qualities of PAA as a function of salt choice were observed. First, regardless of ion choice, the coordination between the carboxylate and the ion inhibit anhydride ring formation (and subsequent decarboxylation). This degradation was replaced with main-chain scission occurring discreetly at higher temperatures. Second, the temperature at which the aforementioned main-chain scission occurred varied based on the choice of coordinated ion. As suggested by the results below, the presence of both carboxylic acid moieties and carboxylates appears to coordinate with sodium (and other) ions. For example Zn, Ca, Al, Na, Cl, Cu and the like.

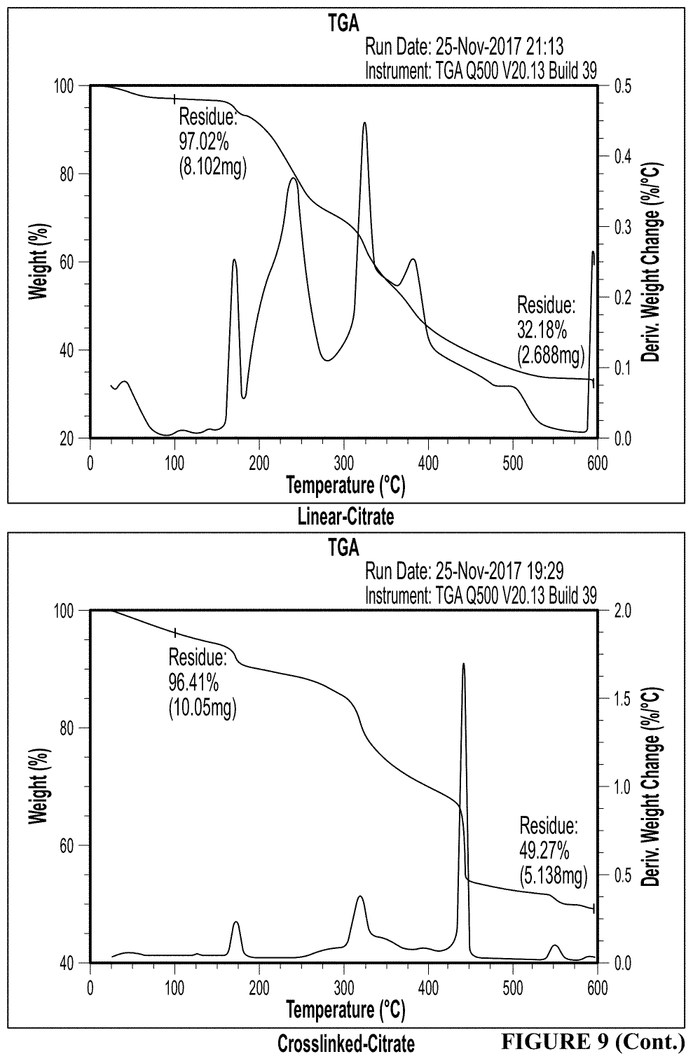

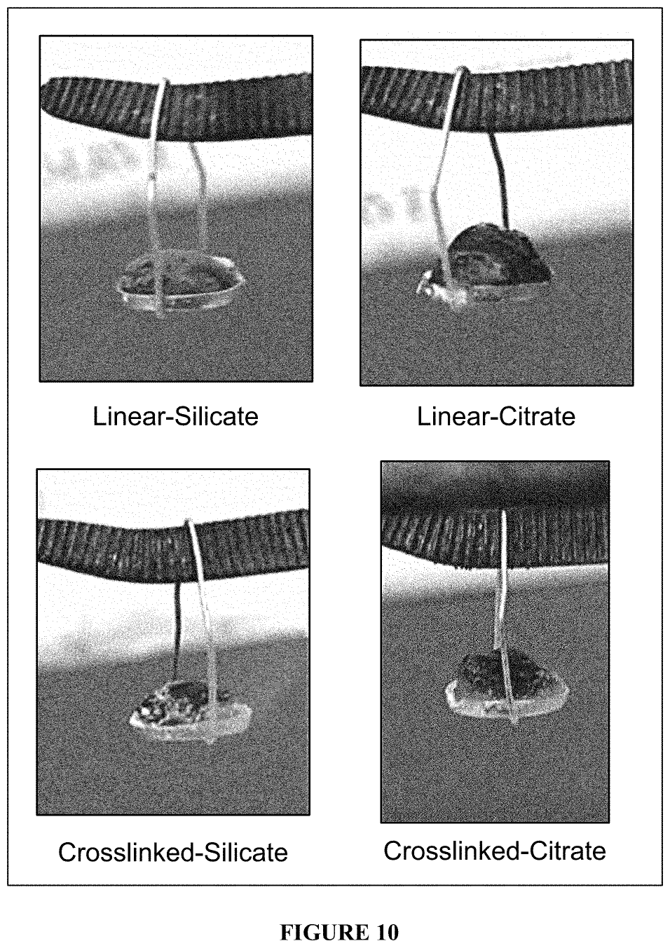

FIG. 9 shows the different degradation profiles of PAA (linear and crosslinked) with silicate ions (from sodium metasilicate) and citrate ions (from citric acid). In turn, FIG. 10 shows photographs of the foamed char of modified PAA with sodium metasilicate or citric acid. This demonstrates that the citrate ions have improved the intumescent properties.

A variety of salts were investigated, but ultimately four were chosen for further investigation: 1) citric acid (CA), 2) Trisodiumcitrate dihydrate (TCD), 3) sodium metasilicate (SM), and 4) calcium silicate (CaSiO). CA and its salted counterpart (TCD) were chosen based on their natural abundance and ability to act as an acid source in intumescent coatings. Sodium metasilicate was chosen due to its inherent flame-retardant capabilities. Finally, calcium silicate was selected based on the additional rigidity afforded by its incorporation.

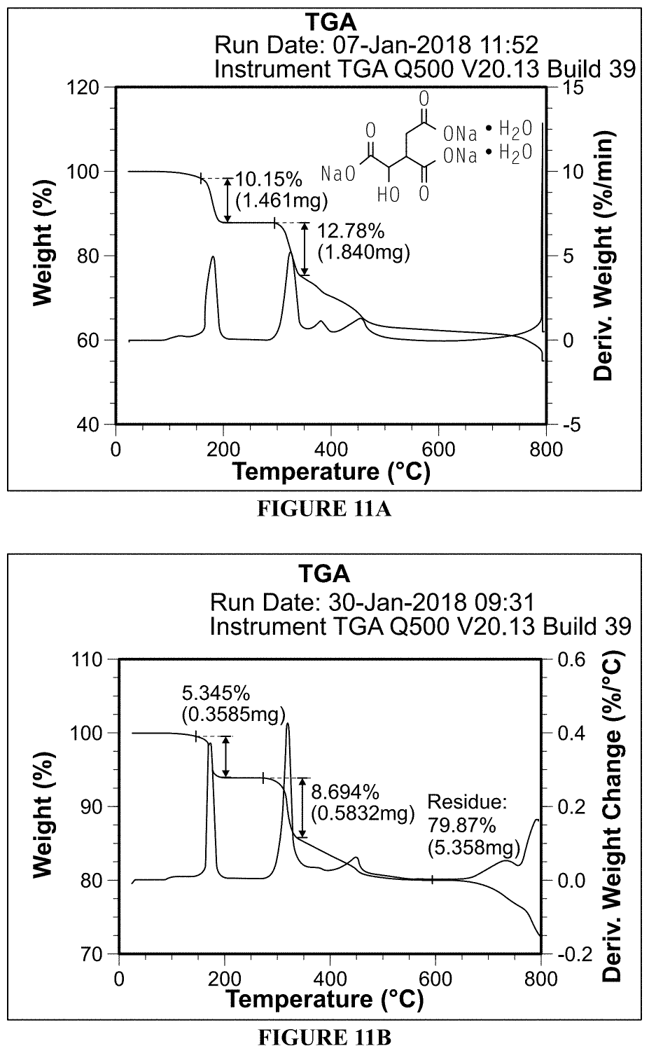

With these characteristics in mind, the obtained TGA data upon blending various minerals with PAA samples gave particularly interesting results. Two mixtures were tested, one incorporating CA and the other TCD. To start, TGA was carried out on each. Subsequently, SM was added to each in a 50:50 weight % ratio and was tested again. Finally, PAA-Na was added to the sample to create a weight % ratio of 25:25:50 of CA (or TCD): SM: PAA-Na. Barring any chemical interactions between the various blend components, a superposition of each additive's TGA would be expected to result. However, as seen in FIG. 11a-c and 12a-c, this is not the case.

FIGS. 11A through 11C show a series of TGA graphs of A) TCD, B) TCD:SM (50:50) and C) TCD:SM:PAA-Na (25:25:50).

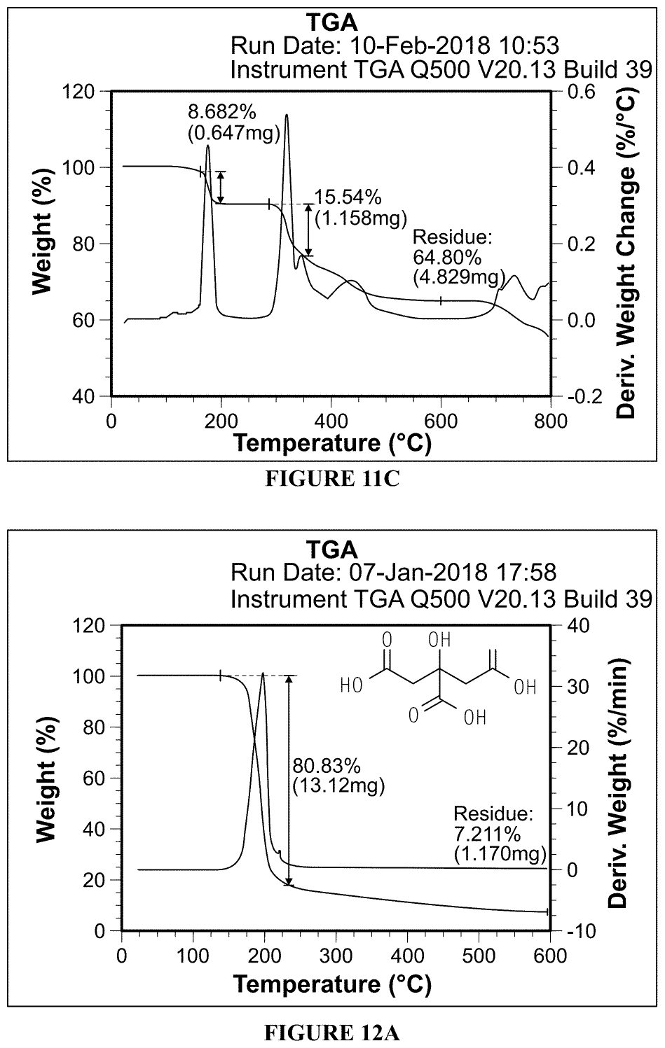

FIGS. 12A through 12C show a series of TGA graphs of A) CA, B) CA:SM (50:50) and C) CA :SM: PAA-Na (25:25:50).

In view of these results, the inventors believe several mechanisms may be at play. First, ion-exchange from the neutralized PAA samples to other molecules (and vice versa) in the melt is hypothesized to occur upon heating. Kinetics are obviously fastest in the melt in terms of chemical reactions, and the energy barrier for these interactions are nearly negligible with consideration of the heat energy supplied to the system.

Another interesting research direction that emerged from these TGAs concerns water of crystallization. Upon TGA of trisodium citrate dihydrate (FIG. 11a), a lack of a water peak at approximately 100° C. is observed that would otherwise correspond to the volatilization of dihydrate. Instead, a peak was observed at approximately 190° C. This implies that the two water molecules were not free water but, instead, bound in the crystal structure of the molecule.

Structurally, there are two differences between CA and TCD. First, TCD has all of the carboxylic acid moieties neutralized with sodium. Second, CA is anhydrous while TCD is a dihydrate. In terms of thermal degradation, CA shows one major degradation peak around 200° C. corresponding to intermolecular anhydride ring formation and subsequent decarboxylation via ring cleavage.

TCD, much like with PAA and its neutralized forms, shows significantly different degradation than its unneutralized analogue. Two major degradation events are observed, one at 190° C. and the other at 325° C. The latter event was attributed to degradation of the secondary alcohol. However, the event at 190° C. was less trivial to assign. No degradation event is observed at 100° C. that would correspond to the volatilization of the two hydrates, which leads to the hypothesis that the release of water occurs instead at this higher temperature. It is further hypothesized that this delayed release is because the dihydrate in TCD are water of crystallization. Embedded in the crystal structure, the water is sterically hindered and unable to volatilize as it normally would at 100° C.

In contrast, SM does not experience similar types of degradation. Structurally, SM is a polymeric structure comprised of a silicon-oxygen backbone with pendant oxygens coordinated to sodium. Commonly used in flame retardant applications, SM is known to form a large oxide structure upon heating. Thus, it can also be selected as an appropriate mineralized additive.

Notwithstanding the focus on the specific mineralized additives discussed above, it will be understood that a wide variety of such additives could be used. As further examples, other hydrates, carbonates, chlorides, nitrates, carbonates, silicates, and/or phosphates may be employed, particularly those having low cost and/or similar characteristics to the other materials described herein. Further, materials that possess similar characteristics and are compatible with PAA and/or formulation of the coating systems should be particularly useful. Additionally or alternatively, structural and chemical analogs and/or derivatives of the materials noted above are also expressly contemplated.

Notably, to the extent citric acid or other potentially reactive compositions are used, it will be understood that these should be incorporated into the formulation in a manner that avoids or largely minimizes any reactions between the additive(s) and the other constituent components of the formulation.

High-velocity, high temperature flame testing was conducted, in the spirit of guidance provided by BS 476-20 and/or ASTM E1529, along with various related methods encompassed by or disclosed in these standards. Both Trisodium citrate dihydrate (TCD) and Citric Acid (CA) modified PAA produced increased expansion compared to PAA alone.

Sodium metasilicate (SM), however, yielded more robust chars but offered limited intumescence. Based on these conclusions, both silicates and citrates were chosen to be blended with PAA samples for epoxy-resin testing in low to moderate concentrations.

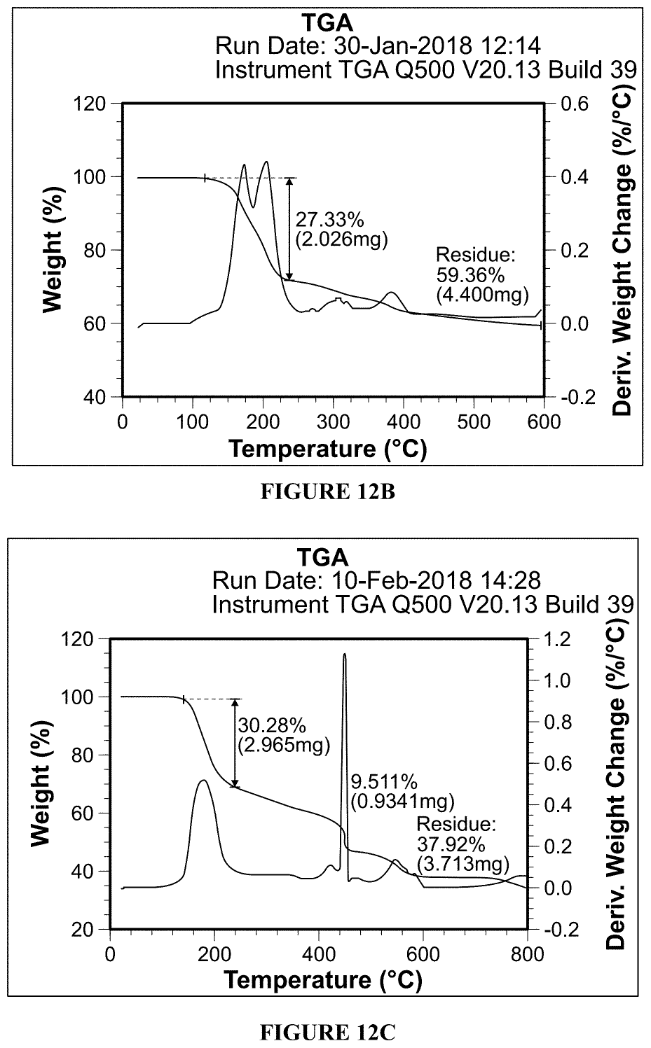

The TGA of other inorganic/PAA mixes were also tested during the course of this investigation are shown as indicated in FIGS. 13A through 13C.

To understand more of the particulars of the heat release profiles of the reactions and potential materials in question, additional testing was performed. For example, microscale combustion calorimetry (MCC) utilizes materials on the milligram-scale to measure oxygen consumption as a function of heating rate. As a result, heat release rate (HRR), peak heat release rate (PHRR), and total heat release (THR) can be quantified to elucidate fundamental properties of the PAA and derivatives of interest.

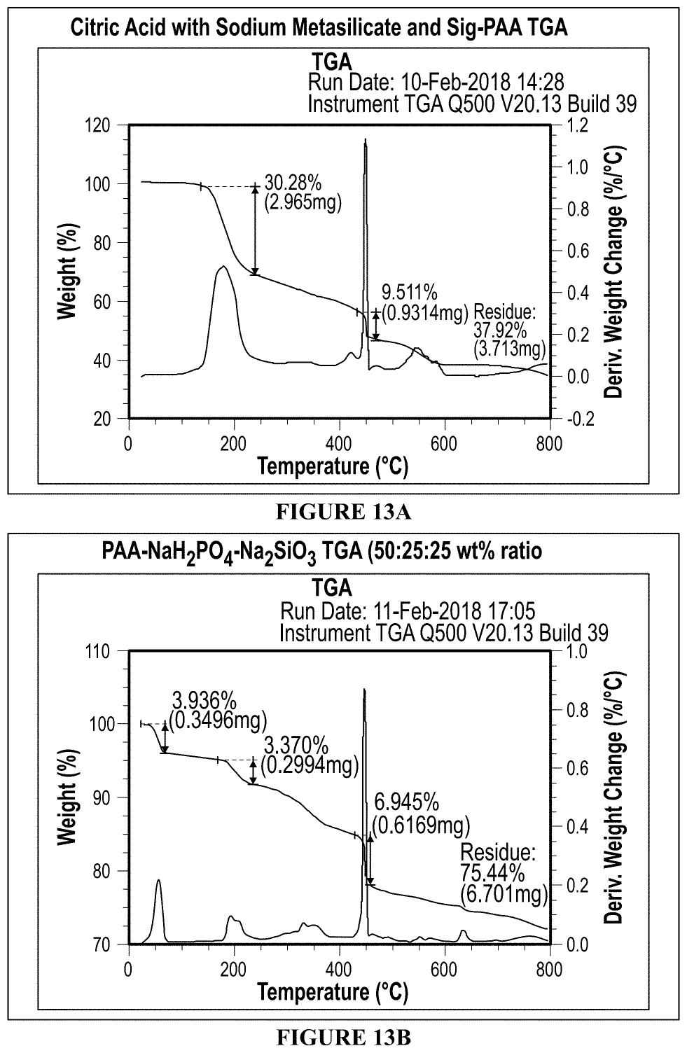

FIG. 14 shows results of microscale combustion calorimetry on various salt forms of PAA. Interestingly, these HRR curves vary significantly with ion choice. For interpretation purposes, the x-axis is interchangeable with temperature as the heating rate was 1° C./s. Lin-PAA-COOH shows a broad heat release rate at 300 seconds, likely corresponding to the heat release by anhydride ring cleavage. Upon salting with sodium, two significant changes are observed. First, the PHRR rate increases by a factor of 3 relative to Lin-PAA-COOH. Second, the THR drops by approximately 20%. Moving from monovalent to divalent ions, calcium acts uniquely as well. Coordination with calcium decreases the total heat release by approximately 45% while maintaining a comparable PHRR as that of Lin-PAA-COOH.

Results in Table 2 above demonstrate increased expansion and char hardness with the addition of PAA-Na and various inorganic compounds. The results also show an increase in expansion and char hardness with the addition citric acid. PVOH also provided improved char hardness.

Laboratory Meker tests shown in Table 3 and described below were conducted on basic epoxy based intumescent formulations containing the PAA additive, Ammonium Polyphosphate (APP) and Melamine. In each of these formulations, at least twice as much APP (by weight) was provided in comparison to the other components, while the PAA-based additive(s) and melamine were added in relatively similar weight ratio amounts.

TABLE 3
Laboratory Meker Test results on formulations containing epoxy,
polyaminoamide, ammonium polyphosphate (APP) and melamine
with different inorganic compounds with and without citric
acid, including an additional test with added PVOH

| Chemicals blended with epoxy/ | | |
|---|---|---|
| amine resin and basic intumescent | | Toughness of |
| ingredients | | char (1-5, 5 = |
| Chemicals | Expansion rate | hardest) |
| No PAA | 6x | 1.5 |
| PAA—Na | 6x | 2.0 |
| PAA—Na/Citric acid | 8.4 | 3.75 |
| PAA—Na/Citric acid/sodium | 14.4x | 3.0 |
| metasilicate | | |
| PAA—Na/Sodium phosphate | 12.6x | 3.0 |
| monobasic/calcium metasilicate | | |
| PAA—Na/Sodium phosphate | 12.2x | 2.5 |
| monobasic/sodium metasilicate | | |
| PAA—Na/Sodium phosphate | 8.1x | 4.0 |
| monobasic/sodium metasilicate/ | | |
| PVOH | | |
| PAA—Na/Trisodium citrate dihydrate/ | 13x | 2.5 |
| sodium metasilicate | | |
| PAA—Na/Calcium silicate (loaded) | 14.3x | 3.5 |

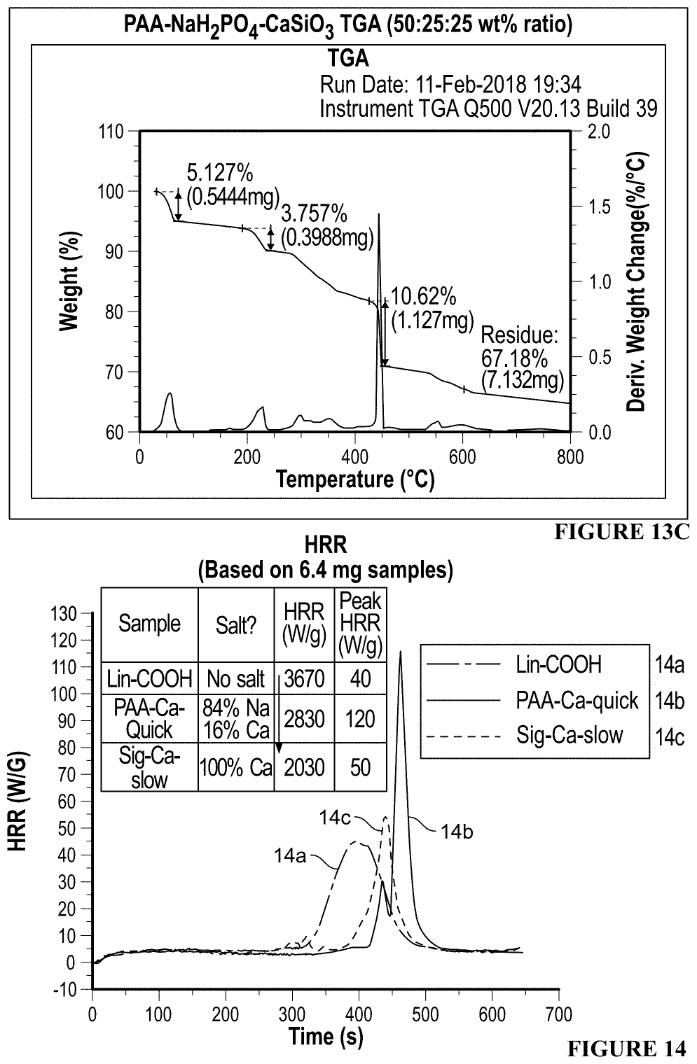

Epoxy based intumescents were prepared containing sodium metasilicate with citric acid and sodium treated PAA (25:25:50 weight % ratio). The char expanded 4 times its own volume after fire test. The burnt char foam was hard and tough (as shown in FIG. 15) possibly suitable for hydrocarbon intumescent fires and jet fires.

Finally, polyvinyl alcohol (PVOH) improved the char toughness of an intumescent paint containing PAA. Further synergies might be realized in combining PAA, PVOH, Poly (ethylene-vinyl acetate) (PEVAC) and Polyvinyl acetate (PVAC), as well as their derivatives.

In all of the foregoing aspects, intumescent compositions were created without relying upon expanded graphite or additives such as boric acid. This approach results in a more cost effective and environmentally friendly formulation that represents an improvement over the prior approaches noted herein. Nevertheless, intumescent performance of the inventive compositions contemplated herein may be enhanced by providing reduced amounts of these substances.

As shown in the examples below, PAA and/or modified PAA should be provided as at least 5.0 wt. %, at least 7.5 wt. %, or at least 10 wt. % in comparison to the entirety of the composition. The inventive compositions can include as much as 20 wt. %, 25 wt. %, or even 50 wt. % or more of PAA and/or modified PAA (relative to the entire composition). As little as 0.5 wt. % may still deliver some marginal benefits contemplated herein when PAA is incorporated as part of the intumescent package, but although its low cost and stated benefits inform the minimums stated above.

Thermoplastic and/or thermosetting resins may be are provided as part of the coating binder system. In particular, epoxies, polyamide, polyaminoamide, polyamine, polyurethane, polyether, acrylics, acrylates, unsaturated polyesters, vinyl esters, polysiloxanes and silicones can be used. One aspect of particular interest focuses on epoxy-based coating binder systems. Generally speaking, the coating binder system will form the bulk of the inventive compositions, usually between about 25.0 to 75.0 wt. %. Multiple resins, curatives, and other additives may be provided to enhance certain desired traits of the binder system, as is known in this field. The remainder of the mass of the composition will include the intumescent package, including any combination of the elements described above. Other additives and modifiers can also be included as part of this remainder.

Understanding that a wide range of grades of PAA are available, PAA materials with a molecular weight of at least 1,000, at least 2,000 daltons, or at least 7,000 daltons should be used. The upper range of molecular weight is less than 1.5 million daltons or less than 500,000 daltons, although these limits will be influenced based upon the linear and/or cross-linked nature of the PAA as well as whether the PAA is provided as a homo or copolymer. Generally speaking, the molecular weight can serve as a proxy for the extent of neutralization in a given grade of PAA, with higher molecular weights tending to be slightly acidic (i.e., not neutralized). Notably, addition of certain PAA modifiers, particularly when that additive is a weak acid such as citric acid, can serve as a de facto means of adjusting the state of neutralization of the PAA. PAA that is at least partially neutralized and at least partially cross linked have proven to be particularly useful, although un-neutralized, fully neutralized, non-crosslinked, and fully cross-linked iterations of PAA could also be used.

### EXAMPLES

Chemicals used: Lightly neutralized (with sodium), lightly crosslinked poly(acrylic acid), sodium silicate, sodium phosphate monobasic, linear poly(acrylic acid) (450 KDa), calcium silicate, trisodium citrate dihydrate, citric acid, sodium hydroxide, calcium hydroxide, calcium chloride, polyvinyl alcohol, and melamine were all obtained from Sigma Aldrich and used without further purification BPA-based epoxy and tetraethylene pentamine were obtained from Hexion Inc. without need for further purification. Carbopol 971P NF and Noveon AA-1 polycarbophil USP were obtained from Lubrizol Corporation. Boric acid (<500 um particle size) may be obtained from Quiborax.

### Preparation and Characterization of Mineralized PAA

Mineralizing PAA using NaOH: The mineralization was performed on PAA by dissolving 80 grams of unmodified PAA in 4 liters of 0.5 M NaOH until completely dissolved. The PAA was then extracted via precipitation in cold methanol. A ratio of about 3:1 (methanol:water) was used to ensure complete extraction. After decanting off the methanol solution, the solid was dried at 80° C. and was dried again after grinding to a powder to ensure dry sample (confirmed via TGA). The resultant polymer was a white solid.

Calcium mineralization of unmodified PAA was done by dissolving 80 grams of unmodified PAA in 4 liters of 5M CaCl₂ until completely dissolved. The PAA was then extracted via precipitation in cold methanol. A ratio of about 3:1 (methanol:water) was used to ensure complete extraction. After decanting off the methanol solution, the solid was dried at 80° C. and was dried again after grinded to a powder completely dry (confirmed via TGA). The resultant polymer was a white solid.

### Analytical Methods—Thermal Characterisation of PAA and Modified Derivatives

Various experiments were carried out to confirm the viability of at least some of the aspects of the invention contemplated herein.

Thermogravimetric analysis (TGA) was performed. The samples were heated from 20° C. to 600° C. at a rate of 5 or 10° C./min under air or nitrogen gas using 8-10 mg samples. This was performed on a TA Instruments brand Q500 TGA. Software workup was done on Universal Analysis™ program.

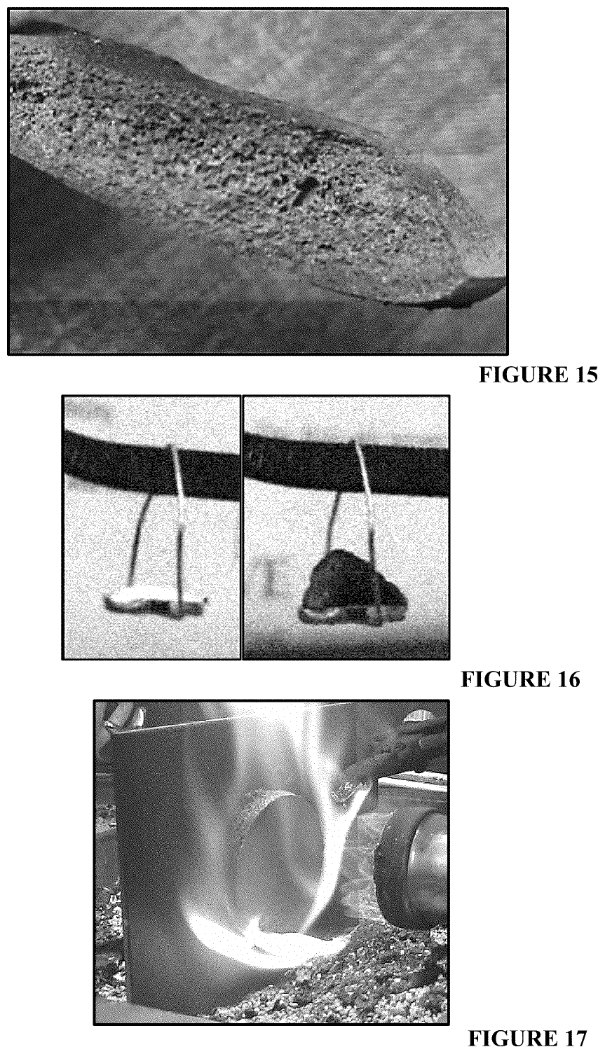

Propane torch tests were designed to replicate high-velocity, high-temperature flames using a generic propane blowtorch. Approximately 15 mg samples were deposited into a platinum TGA pan and held 8-10 inches from the cone of the torch flame. Preliminary intumescent capability was evaluated qualitatively via observation. (see FIG. 16 propane torch test before and after photograph).

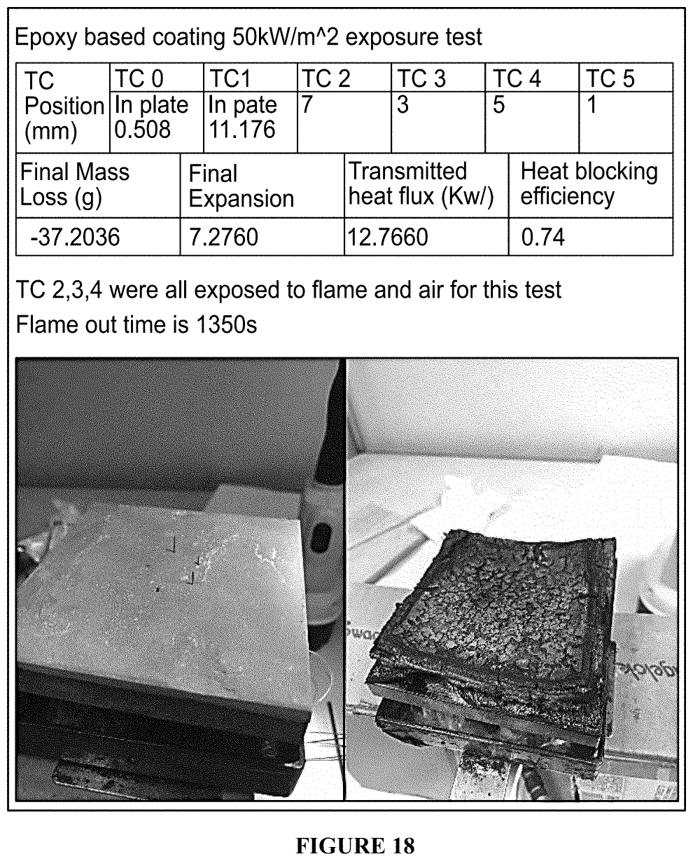

A laboratory Meker burner test was used to gauge optimal intumescence of the PAA/mineral blends in the epoxy resin systems, as depicted in FIG. 17. A Bunsen burner creates a laminar flame, which rarely occurs in real fires. The grating on the front of the Meker burner ensures a turbulent flame, more realistically mimicking a flame. Additionally, 3×3×0.5 cm³ cured ‘pucks’ of coating were utilized instead of fully coating the steel plate upon which they were cured. While an idealized test, the use of a ‘puck’ allowed better evaluation of the intumescent ability of the coatings due to increased surface area exposed to the flame. These samples were burned, with the burner set 5 cm away from the surface of the coating, for 5 minutes to observe the degree of intumescence (swelling). Results were qualitatively determined via the degree of expansion relative to the initial and final coating thicknesses and char quality/hardness.

Microscale combustion calorimetry (MCC) was performed on all powder samples at a heating rate of 1° C. per minute to 600° C. Sample sizes ranged from 5-10 mg. Testing was performed on a Fire Testing Technology brand microscale combustion calorimeter. Data workup performed via Origin brand software.

Cone heater testing utilizes an apparatus that adheres to ASTM standard E2102. This instrument utilizes a radiant cone heater above a variable-height sample stage that doubles as a mass balance. As the sample expands, a laser line is disrupted that subsequently adjusts sample-stage height. 6 K-type thermocouples protrude different distances through the coating and plate that are attached to a Medtherm brand heat flux transducer. Samples were tested for one hour at 50 kW/m 2. Preliminary example data is shown below.

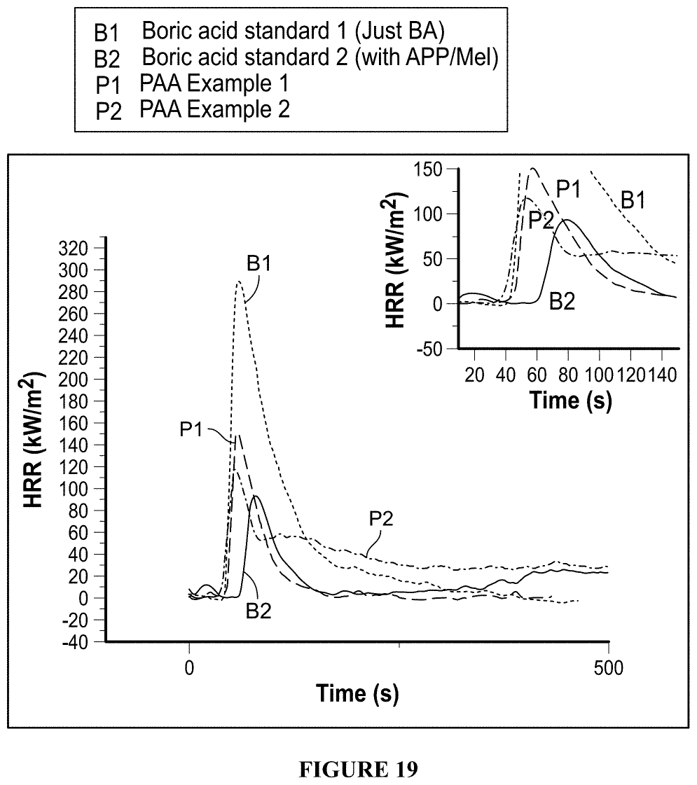

FIG. 18 describes the conditions and shows photographs of the cone heater results for an example boric acid-free experimental formulation containing PAA

Thermal Insulation test is a preliminary test to judge whether or not cone heater testing would be performed. The thermal insulation test was utilized to measure heat that passes through the coating and into the underlying steel plate as a function of time. Typical experiments were conducted on a 15×10×0.3 cm³ steel plate with a 5 mm formulation coating. The plate was situated vertically, 5 cm away from a horizontally facing Meker torch. 12 inches away, a UV-thermometer was placed that took temperature measurements of the back of the plate every 30 seconds.

Cone calorimetry (CC) was performed on all epoxy formulations coated on a 10×10×0.5 cm 3 fully coated steel plate upon which intumescent coating was cured. Using an incident heat flux of 50 kW/m 2, samples were run for 5 minutes. Testing was performed on a Fire Testing Technology brand cone calorimeter. Data workup was performed via MatLab software. Each formulation was tested three times to ensure statistically significant results.

### Epoxy Formulations and Fire Testing

Meker preparation. Initially basic epoxy formulations were designed with 11 or 22 weight % PAA additive, with the remaining weight % being resin. In a given sample, 12.3 g of epoxy was weighed into a 100 mL teflon dish. The additive (2.5 g for PAA-based samples and 5.5 g for mineralized PAA) was added to the epoxy and mixed for 5-10 minutes to ensure a completely homogeneous paste/viscous liquid. Consistency of the epoxy/additive was not uniform between samples, giving a variety of viscosities.

After 5 minutes 7.3 g of amine curing agent was stirred into the Teflon dish and stirred for 5-10 minutes. Regardless of formulation viscosity, the epoxy was cast onto a steel plate using a 3×3×0.5 cm³ mold. Samples were placed in a vacuum desiccator for an hour, followed by a 60° C. oven for 4 hours. All samples were allowed to cool to room temperature before meker burning.

Subsequently, Boric acid-free intumescent formulations (see above) were used as exemplary coatings. In a given sample, the formulated boric acid-free intumescent epoxy (Part A) was weighed into a 100 mL teflon dish. The PAA additives were then added and mixed for 5-10 minutes to ensure a completely homogeneous paste/viscous liquid.

After 5 minutes, the formulated Boric acid-free intumescent amine curing agent (Part B) was stirred into a Teflon dish and stirred for 5-10 minutes. Regardless of formulation viscosity, the mixtures were cast on to steel plates (A-12 construction steel) with a 3×3×0.5 cm³ Teflon mold. Samples were then placed in a vacuum desiccator for an hour, followed by a 60° C. oven for 4 hours. Upon cooling, samples were removed from the mold and sanded to ensure uniform thickness.

### Working Examples

Table 4 shows how each of these coatings were formulated, with further reference to the abbreviations and procedures noted above.

TABLE 4
Intumescent coating formulations based on identical resins and
varied components.

| | EXAMPLES | | | | | |
|---|---|---|---|---|---|---|
| | | | | | | 6 |
| | | | | | | Commercial |
| | 1 | 2 | 3 | 4 | 5 | Intumescent |
| Part A | | | | | | |
| Titanium dioxide | 2 | 2 | 2 | 2 | 2 | |
| Ammonium Polyphosphate | 10 | 10 | 10 | 10 | 10 | |
| Other inorganic fillers | 9.5 | 9.5 | 9.5 | 9.5 | 9.5 | |
| Thixotropic wax | 0.5 | 0.5 | 0.5 | 0.5 | 0.5 | |
| Diluent | 11 | 11 | 11 | 11 | 11 | |
| Epoxy Resin | 32 | 32 | 32 | 32 | 32 | |
| | | | | | | 65 |
| Part B | | | | | | |
| Other inorganic fillers | 3.8 | 3.8 | 3.8 | 3.8 | 3.8 | |
| Melamine (blowing agent) | 7 | 7 | 7 | 7 | 7 | |
| Thixotropic wax | 1.5 | 1.5 | 1.5 | 1.5 | 1.5 | |
| Polyaminoamide | 22 | 22 | 22 | 22 | 22 | |
| Reactive Amine Catalyst | 0.7 | 0.7 | 0.7 | 0.7 | 0.7 | |
| Total 100.01 | | | | | | 35.01 |
| PAA | | | 14 | 27.5 | 11 | |
| unmodified | | | | | | |
| PAA-Na | 13.75 | 27.5 | 14 | | | |
| SM | 3.5 | | | | | |
| CA | 3.5 | | | | | |
| PVOH | | | | | 16.5 | |
| Total weight | 120.76 | 127.51 | 128.01 | 127.51 | 127.51 | |
| expansion ratio | 4.1 | 2.2 | 2.9 | 9.4 | 4.7 | 6 |
| Rough Char toughness scale | 5//5 | 5//5 | 5//5 | 3.75//5 | 5//5 | 5//5 |

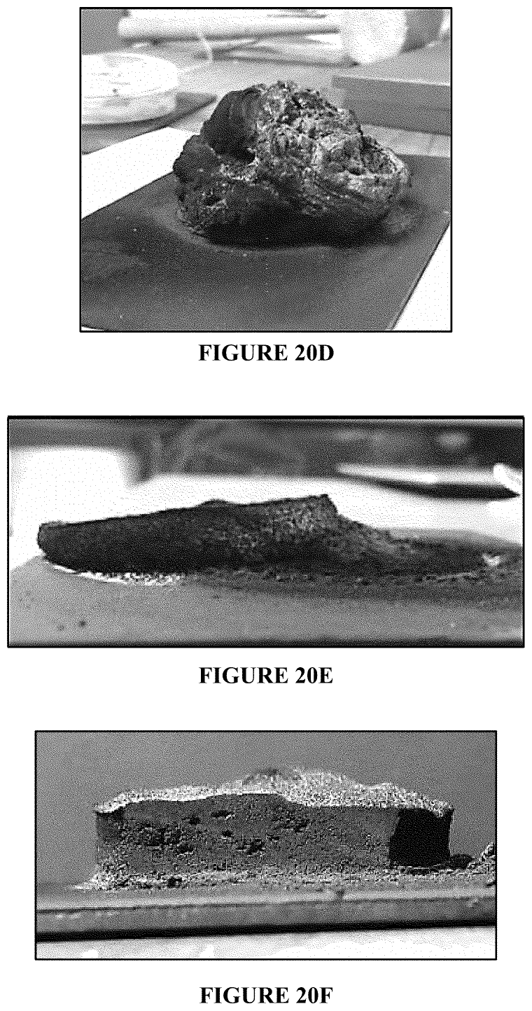

FIGS. 20A through 20E show the char structure produced by Meker testing on formulations 1, 2, 3, 4 and 5 from Table 4, while FIG. 20F shows the same in a commercially available Boric acid containing formulation.

Additional promising formulations that warrant further investigation are samples including Poly(vinyl alcohol)(PVOH). A polyphenolic species, PVOH possesses a plethora of hydroxyl moieties readily available for ether formation. In addition, as degradation occurs, areas of unsaturation occur along the backbone, a common precursor to char. PVOH's incorporation in to epoxy formulations has been reported in literature in recent years, and should be an aim of further investigation in to epoxy formulations.

Thermal insulation testing (FIG. 16) of an commercial intumescent containing boric acid versus experimental formulations containing PAA (Example 4) and Example 1) showed that the experimental formulations performed close to that of the Boric acid containing commercial product.

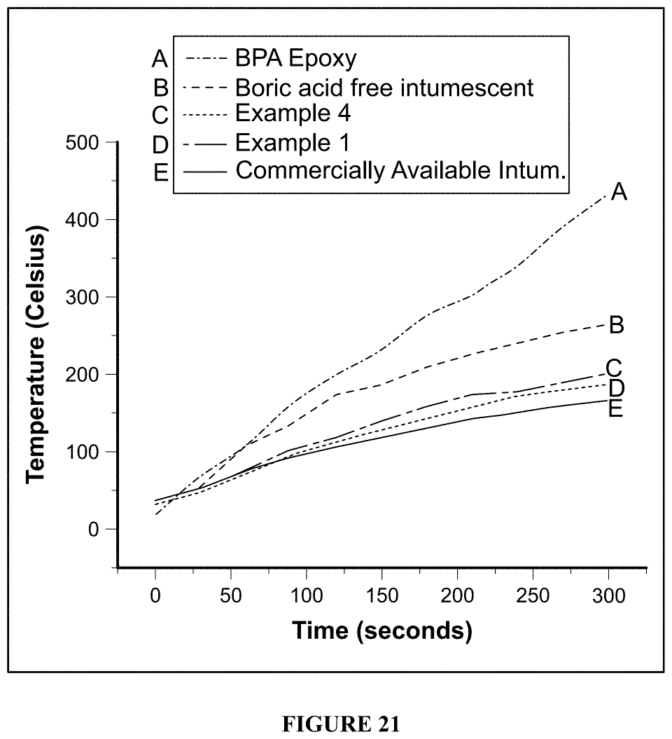

In FIG. 21, Line A shows a bisphenol A epoxy coating (i.e. a control coating with no intumescent ingredients), Line B is a boric acid and PAA free experimental formulation. Line C is the boric acid free experimental formulation containing PAA and Line D is the boric acid free experimental formulation containing PAA (Example 1), and Line E is a commercially available, boric acid containing intumescent coating. The graph demonstrates that modified PAA with inorganic compounds showed very good thermal insulation performance with respect to temperature and time compared to the commercial product.

In various aspects of the invention, an intumescent coating composition and, in some cases, a liquid intumescent coating composition may include any combination of the following features:
a coating binder system;
an intumescent package having poly(acrylic acid) and a PAA modifier;
wherein the coating binder system comprises between 25.0 to 75.0 wt. % of at least one thermosetting polymer and at least one curing agent thereof;
wherein the PAA modifier includes at least one of the following: poly(vinyl alcohol), poly(vinyl acetate), and combinations thereof;
wherein the PAA modifier is an inorganic mineral;
wherein the PAA modifier includes at least one metal selected from: Al, B, Zr, Cu, Zn, Na, K, Mg, Ca, Sr, Si, and Ti;
wherein the metal is associated, incorporated, or complexed with at least one selected from: a hydrate, a hydroxide, an oxide, a carbonate, a bicarbonate, a silicate, a sulfate, a nitrate, a chloride and a phosphate;
wherein the PAA modifier comprises a weak organic acid;
wherein the weak organic acid includes citric acid, tartaric acid, ascorbic acid, lactic acid, formic acid, acetic acid, oxalic acid, uric acid, malic acid and/or itaconic acid;
wherein the poly(acrylic) acid is at least partially neutralized;
wherein the poly(acrylic) acid is at least partially cross-linked;
wherein the poly(acrylic) acid comprises at least 5.0 wt. % of the coating composition;
wherein the poly(acrylic) acid comprises no more than 50 wt. % of the coating composition;
wherein the poly(acrylic) acid has a molecular weight of at least 1,000 daltons;
wherein the poly(acrylic) acid has a molecular weight of at least 2,000 daltons;
wherein the poly(acrylic) acid has a molecular weight of no more than 1,500,000 daltons;
wherein the poly(acrylic) acid has a molecular weight of no more than 500,000 daltons;
wherein the coating binder is thermoset or thermoplastic;
wherein the thermosetting binder system utilizes a single cure mechanism, a dual cure mechanism, peroxide cure, redox cure or UV curing mechanisms;
wherein the thermosetting binder contains an epoxy;
wherein the thermosetting binder contains an epoxy and an amide;
wherein the dual cure mechanism includes an epoxy amide reaction and a Michael addition reaction; and
wherein the thermoplastic binder system is based on vinyl, styrene, acrylic or acrylate chemistry.

Upon coupling with inorganic compounds and integrating into epoxy or other coatings, PAA blends were found to create expansive and robust chars with heat blocking efficiencies comparable to that of commercially available intumescent coatings. As such, these PAA-based materials should have particular utility in a wide range of intumescent compositions and coating systems.

Generally speaking, chemical components and related constituent items should also be selected for workability, cost, and weight. Unless specifically noted, all tests and measurements are conducted in ambient conditions and relying upon commercially available instruments according to the manufacturer-recommended operating procedures and conditions. Unless noted to the contrary (explicitly or within the context of a given disclosure), all measurements are in grams and all percentages are based upon weight percentages.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof.

What is claimed is:

1. An intumescent coating composition comprising:
a coating binder system; and
an intumescent package having poly(acrylic acid) and a PAA modifier.

2. The coating composition of claim 1 wherein the coating binder system comprises between 25.0 to 75.0 wt. % of at least one resin and at least one curing agent thereof.

3. The coating composition of claim 1 wherein the PAA modifier also includes at least one of the following: poly(vinyl alcohol), poly(vinyl acetate), and combinations thereof.

4. The coating composition of claims 1 wherein the PAA modifier is an inorganic mineral.

5. The coating composition of claim 1 wherein the PAA modifier includes at least one metal selected from: Al, B, Zr, Cu, Zn, Na, K, Mg, Ca, Sr, Si, and Ti.

6. The coating composition of claim 5 wherein the metal is associated, incorporated, or complexed with at least one selected from: a hydrate, a hydroxide, an oxide, a carbonate, a bicarbonate, a silicate, a sulfate, a nitrate, a chloride and a phosphate.

7. The coating composition of claim 1 wherein the PAA modifier comprises a weak organic acid.

8. The coating composition of claim 7 wherein the weak organic acid is at least one selected from citric acid, tartaric acid, ascorbic acid, lactic acid, formic acid, acetic acid, oxalic acid, uric acid, malic acid, itaconic acid , and any combination of two or more thereof.

9. The coating composition of claim 1 wherein the poly(acrylic) acid is not neutralized.

10. The coating composition of claim 1 wherein the poly(acrylic) acid is at least partially neutralized.

10. The coating composition of claim 1 wherein the poly(acrylic) acid is at least partially cross-linked.

11. The coating composition of claim 2 wherein the poly(acrylic) acid comprises at least 5.0 wt. % of the coating composition.

12. The coating composition of claim 11 wherein the poly(acrylic) acid comprises no more than 50 wt. % of the coating composition.

13. The coating composition of claim 1 wherein the poly(acrylic) acid has a molecular weight of at least 1,000 daltons.

14. The coating composition of claim 1 wherein the poly(acrylic) acid has a molecular weight of at least 2,000 daltons.

15. The coating composition of claim 1 wherein the poly(acrylic) acid has a molecular weight of no more than 1,500,000 daltons.

16. The coating composition of claim 1 wherein the poly(acrylic) acid has a molecular weight of no more than 500,000 daltons.

17. The coating composition of claim 2 wherein the at least one resin is an epoxy.

18. The coating composition of claim 1 wherein the coating binder system includes at least one polymer having polymer having one or more of the following functional groups: epoxy, amine, urethane, isocyanate, ester, vinyl, vinyl ester, amide, mercaptan, carboxylic acid, acryloyl, methacryloyl, anhydride, hydroxyl, alkoxy, and hybrids thereof.
